(19) United States
(12) Patent Application Publication
(10) Pub. No.: US 2023/0138595 A1
(43) Pub. Date: May 4, 2023

(54) Radio Configuration Parameter Optimization by Using a Dual Control Algorithm

(71) Applicant: Nokia Solutions and Networks Oy, Espoo (FI)

(72) Inventors: Jian Song, Palaiseau (FR); Istvan Zsolt Kovacs, Aalborg (DK); Muhammad Majid Butt, Naperville, IL (US); Klaus Ingemann Pedersen, Aalborg (DK)

(21) Appl. No.: 17/972,096

(22) Filed: Oct. 24, 2022

(30) Foreign Application Priority Data
Oct. 28, 2021 (FI) 20216119

(51) Int. Cl. H04W 24/02; H04W 24/08; H04W 28/24

(52) U.S. Cl. CPC H04W 24/02; H04W 24/08; H04W 28/24

(57) ABSTRACT

The present disclosure relates to techniques for adaptively controlling and optimizing radio configuration parameters by using a dual control algorithm. The dual control algorithm includes first and second control algorithms, each of which is executed independently whenever certain one or more trigger events occur. The first control algorithm is used for obtaining one or more User Equipment (UE) clusters and a Key Performance Indicator (KPI) requirement for each UE cluster based on UE information, while the second control algorithm is used for obtaining optimized radio configuration parameters for each UE cluster in accordance with the KPI requirement. The second control algorithm is also configured to monitor its performance and, if its performance degrades, send an associated signal to the first control algorithm. The occurrence of such a signal is among the trigger events that cause the execution of the first control algorithm.

### CROSS-REFERENCE TO RELATED APPLICATIONS

The present application claims priority to the Finnish Patent Application No. 20215727, filed with the Finnish Patent and Registration Office on Jun. 21, 2021, entitled “UPLINK TRANSMIT POWER CONTROL”, the entire disclosure of which is hereby incorporated by reference.

### TECHNICAL FIELD

The present disclosure relates generally to the field of wireless communications, and particularly to techniques for adaptively controlling and optimizing radio configuration parameters by using two separate but interconnected control algorithms.

### BACKGROUND

There are multiple examples of Machine Learning (ML) algorithms for a wireless communication network (e.g., a Next-Generation Radio Access Network (NG-RAN)) which offer various Radio Resource Management (RRM) improvements. One of such ML algorithms is a Reinforcement Learning (RL) algorithm that, for example, provides a low-complexity mechanism for solving the problem of User Equipment (UE) transmission parameter optimization for Uplink (UL) Open Loop Power Control (OLPC) for different UE clusters within a serving cell. However, such an RL-based solution typically relies on a set of input parameters which must be chosen carefully to obtain the best performance of the RL algorithm. Moreover, despite the prior art studies, it is still non-trivial how to design a low complexity and, at the same time, robust RL-based solution for radio configuration parameter optimization.

US 2015181519 A1 discloses a network node and a method for controlling uplink power control. The method comprises collecting measurement reports from UEs. The method comprises creating clusters of low power radio base stations (RBSs) and macro RBSs, where each cluster comprises one low power RBS and at least one macro RBS. The method further comprises identifying the macro RBS with the lowest path loss for those UEs connected to the low power RBS, and determining the level of the path loss and an interference level in the low power RBS caused by UEs connected to the macro RBS for those UEs connected to the macro RBS.

The prior art also discloses a robust two-level learning approach for power control in uplink ultra-dense heterogeneous networks (HetNets) (see MAKHANBET, M. ET AL. Users first: a robust two-level learning of power control in uplink ultra-dense HetNets. In: IEEE Access Nov. 16, 2020, Vol. 8, 205712-205726, <DOI:10.1109/ACCESS.2020.3037737>). According to this approach, the per-user power control allows users to transmit with full power to maintain a stable connection, but it also causes a higher outage probability during the uplink transmission. A robust distributed energy-efficient uplink power control scheme in the HetNets is also proposed, which accounts for multi-user interference coordination. A JarvisPatric (JP) algorithm is adopted for the users' clustering, with an extra term named degree of membership. A novel 2-level distributed cooperative learning (DCL) scheme is also proposed, where users act as self-organized agents and optimize power control at local and global levels jointly.

Common to the prior art ML/RL-based solutions is that they do not give details for the most efficient algorithm initialization, as well as do not explain how to select a detailed ML/RL algorithm for UE clustering within the serving cell and radio configuration parameter optimization.

There is therefore a need for a technical solution that enables the efficient online adaptation of the set of the most important (in terms of performance) input parameters which, in turn, control the functionality of a low complexity ML/RL algorithm when the ML/RL algorithm is used for the radio configuration parameter optimization.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that enables radio configuration parameter optimization in a low-complexity, time-efficient and robust manner.

The objective above is achieved by the features of the independent claims in the appended claims. Further embodiments and examples are apparent from the dependent claims, the detailed description and the accompanying drawings.

According to a first aspect, a network node in a wireless communication network is provided. The network comprises at least one processor and at least one memory. The at least one memory comprises a computer program code. The at least one memory and the computer program code are configured to, with the at least one processor, cause the network node to operate at least as follows. At first, the network node is caused to receive UE information from at least one UE present within a cell served by the network node. Then, the network node is caused to obtain, based on the UE information, at least one radio configuration parameter for the at least one UE by using a dual control algorithm. After that, the network node is caused to transmit the at least one radio configuration parameter to the at least one UE. In this example embodiment, the dual control algorithm comprises a first control algorithm and a second control algorithm. The first control algorithm is configured, whenever at least one first trigger event occurs, to: (i) group the at least one UE into at least one UE cluster based on the UE data; (ii) determine at least one Key Performance Indicator (KPI) requirement for each of the at least one UE cluster; and (iii) provide, to the second control algorithm, output data indicating the at least one UE cluster and the at least one KPI requirement for each of the at least one UE cluster. The second control algorithm has a performance metric and is configured, whenever at least one second trigger event occurs, to: (i) obtain the at least one radio configuration parameter based on the output data from the first control algorithm; (ii) check, based on the at least one radio configuration parameter, whether the performance metric degrades; and (iii) if the performance metric degrades, provide a signal indicative of the degraded performance metric to the first control algorithm. The at least one second trigger event is different from the at least one first trigger event, and the at least one first trigger event comprises an event at which the signal indicative of the degraded performance metric is provided to the first control algorithm. Since the first and second control algorithms are coupled via the specified trigger event (i.e., the occurrence of the signal indicative of the degraded performance metric), the second control algorithm may trigger the execution of the first control algorithm in the network node even when all other trigger events are absent (e.g., when there is no change in the radio conditions or load in the cell, no periodic event, etc.). This allows the network node to provide the auto-clustering/grouping of UEs in the cell and the radio configuration parameter optimization per UE cluster/group in a time-efficient and robust manner.

Moreover, the first and second control algorithms thus configured may be used in various RRM mechanisms under potentially low computation complexity. On top of that, the first and second control algorithms thus configured may be implemented within the framework of the current New Radio (NR) specifications without introducing additional specification changes.

In one example embodiment of the first aspect, the at least one memory and the computer program code are further configured to, with the at least one processor, cause the network node to start a periodic timer for the first control algorithm. In this example embodiment, the at least one first trigger event further comprises an event at which the periodic timer for the first control algorithm expires. Thus, the network node may be caused to execute the first control algorithm in response to one more trigger event (in addition to the occurrence of the signal indicative of the degraded performance metric), thereby checking the validity of the current UE clusters and KPI requirements and, if required, updating the current UE clusters and KPI requirements.

In one example embodiment of the first aspect, the at least one memory and the computer program code are further configured to, with the at least one processor, cause the network node to start a periodic timer for the second control algorithm. In this example embodiment, the at least one second trigger event comprises an event at which the periodic timer for the second control algorithm expires. By using such a trigger event for the second control algorithm, it is possible to check the validity of the current radio configuration parameters and, if required, update the current radio configuration parameters.

In one example embodiment of the first aspect, the at least one memory and the computer program code are further configured to, with the at least one processor, cause the network node to monitor a radio condition for the cell and/or the at least one UE cluster. In this example embodiment, the at least one first trigger event further comprises an event at which the radio condition for the cell and/or any of the at least one UE cluster changes. Thus, the network node may be caused to execute the first control algorithm in response to one more trigger event (in addition to the occurrence of the signal indicative of the degraded performance metric), thereby checking the validity of the current UE clusters and KPI requirements and, if required, updating the current UE clusters and KPI requirements.

In one example embodiment of the first aspect, the first control algorithm is further configured to provide, to the second control algorithm, a signal indicative of the changed radio condition for the cell and/or any of the at least one UE cluster. In this example embodiment, the at least one second trigger event further comprises an event at which the signal indicative of the changed radio condition for the cell and/or any of the at least one UE cluster is provided to the second control algorithm. By using such a trigger event for the second control algorithm, it is possible to check the validity of the current radio configuration parameters and, if required, update the current radio configuration parameters.

In one example embodiment of the first aspect, the UE information comprises at least one of: a UE type, a type and/or quality of at least one communication service to be used, and a type of at least one radio configuration parameter to be used. By using such UE information, the first control algorithm may perform the UE auto-clustering in a variety of ways (e.g., such that each UE cluster comprises UEs of the same type).

In one example embodiment of the first aspect, the KPI requirement comprises at least one of a Quality-of-Service (QoS) requirement, a throughput requirement, and an uplink (UL) power requirement. By using these requirements, the network node may manage data traffic to reduce packet loss, latency and jitter in the wireless communication network.

In one example embodiment of the first aspect, the at least one radio configuration parameter comprises at least one of a radio resource, a transmission power control parameter, a measurement gap, an UL beamforming parameter, and a number of supported timing advance groups (i.e., the number of groups of serving cells which have the same timing advance value for an UL). This may make the network node more flexible in use. For example, the network node may execute the first and second control algorithms for the following two purposes: RRM and UL OLPC.

In one example embodiment of the first aspect, the first control algorithm comprises at least one of an ML algorithm and a rule-based algorithm. By using these algorithm types, the network node may provide the UE clustering in a more efficient manner.

In one example embodiment of the first aspect, the second control algorithm comprises a ML algorithm (e.g., a Reinforcement Learning (RL) algorithm). By using the ML algorithm as the second control algorithm, the network node may perform the radio configuration parameter optimization in a more efficient manner.

In one example embodiment of the first aspect, the at least one memory and the computer program code are further configured to, with the at least one processor, cause the network node to receive, from another network node, UE-specific historical data for the at least one UE. The UE-specific historical data may relate to a UE transmission performance over time and/or the UE transmission performance over a UE location within the cell. In this example embodiment, the first control algorithm may be configured to group the at least one UE into the at least one UE cluster based on the UE information and the UE-specific historical data. By so doing, the UE clustering may be performed more efficiently.

According to a second aspect, a method for operating a network node in a wireless communication network is provided. The method starts with the step of receiving UE information from at least one UE present within a cell served by the network node. Then, the method proceeds to the step of obtaining, based on the UE information, at least one radio configuration parameter for the at least one UE by using a dual control algorithm. After that, the method goes on to the step of transmitting the at least one radio configuration parameter to the at least one UE. In this example embodiment, the dual control algorithm comprises a first control algorithm and a second control algorithm. The first control algorithm is configured, whenever at least one first trigger event occurs, to: (i) group the at least one UE into at least one UE cluster based on the UE information; (ii) determine a KPI requirement for each of the at least one UE cluster; and (iii) provide, to the second control algorithm, output data indicating the at least one UE cluster and the KPI requirement for each of the at least one UE cluster. The second control algorithm has a performance metric and is configured, whenever at least one second trigger event occurs, to: (i) obtain the at least one radio configuration parameter based on the output data from the first control algorithm; (ii) check, based on the at least one radio configuration parameter, whether the performance metric degrades; and (iii) if the performance metric degrades, provide a signal indicative of the degraded performance metric to the first control algorithm. The at least one second trigger event is different from the at least one first trigger event, and the at least one first trigger event comprises an event at which the signal indicative of the degraded performance metric is provided to the first control algorithm. Since the first and second control algorithms are coupled via the specified trigger event (i.e., the occurrence of the signal indicative of the degraded performance metric), the second control algorithm may trigger the execution of the first control algorithm even when all other trigger events are absent (e.g., when there is no change in the radio conditions or load in the cell, no periodic event, etc.). This allows the network node to provide the auto-clustering/grouping of UEs in the cell and the radio configuration parameter optimization per UE cluster/group in a time efficient and robust manner. Moreover, the first and second control algorithms thus configured may be used in various RRM mechanisms under potentially low computation complexity. On top of that, the first and second control algorithms thus configured may be implemented within the framework of the current NR specifications without introducing additional specification changes.

In one example embodiment of the second aspect, the method further comprises the step of starting a periodic timer for the first control algorithm. In this example embodiment, the at least one first trigger event further comprises an event at which the periodic timer for the first control algorithm expires. Thus, the first control algorithm may be executed in response to one more trigger event (in addition to the occurrence of the signal indicative of the degraded performance metric), thereby checking the validity of the current UE clusters and KPI requirements and, if required, updating the current UE clusters and KPI requirements.

In one example embodiment of the second aspect, the method further comprises the step of starting a periodic timer for the second control algorithm. In this example embodiment, the at least one second trigger event comprises an event at which the periodic timer for the second control algorithm expires. By using such a trigger event for the second control algorithm, it is possible to check the validity of the current radio configuration parameters and, if required, update the current radio configuration parameters.

In one example embodiment of the second aspect, the method further comprises the step of monitoring a radio condition for the cell and/or the at least one UE cluster. In this example embodiment, the at least one first trigger event further comprises an event at which the radio condition for the cell and/or any of the at least one UE cluster changes. Thus, the first control algorithm may be executed in response to one more trigger event (in addition to the occurrence of the signal indicative of the degraded performance metric), thereby checking the validity of the current UE clusters and KPI requirements and, if required, updating the current UE clusters and KPI requirements.

In one example embodiment of the second aspect, the first control algorithm is further configured to provide, to the second control algorithm, a signal indicative of the changed radio condition for the cell and/or any of the at least one UE cluster. In this example embodiment, the at least one second trigger event further comprises an event at which the signal indicative of the changed radio condition for the cell and/or any of the at least one UE cluster is provided to the second control algorithm. By using such a trigger event for the second control algorithm, it is possible to check the validity of the current radio configuration parameters and, if required, update the current radio configuration parameters.

In one example embodiment of the second aspect, the UE information comprises at least one of: a UE type, a type and/or quality of at least one communication service to be used, and a type of at least one radio configuration parameter to be used. By using such UE information, the first control algorithm may perform the UE auto-clustering in a variety of ways (e.g., such that each UE cluster comprises UEs of the same type).

In one example embodiment of the second aspect, the KPI requirement comprises at least one of a QoS requirement, a throughput requirement, and an UL power requirement. By using these requirements, it is possible to manage data traffic to reduce packet loss, latency and jitter in the wireless communication network.

In one example embodiment of the second aspect, the at least one radio configuration parameter comprises at least one of a radio resource, a transmission power control parameter, a measurement gap, an UL beamforming parameter, and a number of supported timing advance groups. This may make the method more flexible in use. For example, the first and second control algorithms may be executed for the following two purposes: RRM and UL OLPC.

In one example embodiment of the second aspect, the first control algorithm comprises at least one of a ML algorithm and a rule-based algorithm. By using these algorithm types, the UE clustering may be performed in more efficiently.

In one example embodiment of the second aspect, the second control algorithm comprises a ML algorithm. (e.g., an RL algorithm). By using the ML algorithm as the second control algorithm, it is possible to perform the radio configuration parameter optimization more efficiently.

In one example embodiment of the second aspect, the method further comprises the step of receiving, from another network node, UE-specific historical data for the at least one UE. The UE-specific historical data may relate to a UE transmission performance over time and/or the UE transmission performance over a UE location within the cell. In this example embodiment, the first control algorithm may be configured to group the at least one UE into the at least one UE cluster based on the UE information and the UE-specific historical data. By so doing, the UE clustering may be performed more efficiently.

According to a third aspect, a computer program product is provided. The computer program product comprises a computer-readable storage medium that stores a computer code. Being executed by at least one processor, the computer code causes the at least one processor to perform the method according to the second aspect. By using such a computer program product, it is possible to simplify the implementation of the method according to the second aspect in any network node, like the network node according to the first aspect.

According to a fourth aspect, a network node in a wireless communication network is provided. The network node comprises a means for receiving UE information from at least one UE present within a cell served by the network node. The network node further comprises a means for using the UE information to obtain at least one radio configuration parameter for the at least one UE by using a dual control algorithm, and a means for transmitting the at least one radio configuration parameter to the at least one UE. In this example embodiment, the dual control algorithm comprises a first control algorithm and a second control algorithm. The first control algorithm is configured, whenever at least one first trigger event occurs, to: (i) group the at least one UE into at least one UE cluster based on the UE information; (ii) determine a KPI requirement for each of the at least one UE cluster; and (iii) provide, to the second control algorithm, output data indicating the at least one UE cluster and the KPI requirement for each of the at least one UE cluster. The second control algorithm has a performance metric and is configured, whenever at least one second trigger event occurs, to: (i) obtain the at least one radio configuration parameter based on the output data from the first control algorithm; (ii) check, based on the at least one radio configuration parameter, whether the performance metric degrades; and (iii) if the performance metric degrades, provide a signal indicative of the degraded performance metric to the first control algorithm. The at least one second trigger event is different from the at least one first trigger event, and the at least one first trigger event comprises an event at which the signal indicative of the degraded performance metric is provided to the first control algorithm. Since the first and second control algorithms are coupled via the specified trigger event (i.e., the occurrence of the signal indicative of the degraded performance metric), the second control algorithm may trigger the execution of the first control algorithm even when all other trigger events are absent (e.g., when there is no change in the radio conditions or load in the cell, no periodic event, etc.). This allows the network node to provide the auto-clustering/grouping of UEs in the cell and the UE configuration parameter optimization per UE cluster/group in a time-efficient and robust manner. Moreover, the first and second control algorithms thus configured may be used in various RRM mechanisms under potentially low computation complexity. On top of that, the first and second control algorithms thus configured may be implemented within the framework of the current NR specifications without introducing additional specification changes.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a block diagram of a network node in accordance with one example embodiment;

FIG. 2 shows a flowchart of a method for operating the network node shown in FIG. 1 in accordance with one example embodiment;

FIG. 3 shows a block diagram of a dual control algorithm in accordance with one example embodiment;

FIG. 4 shows a block diagram of a first control algorithm included in the dual control algorithm shown in FIG. 3 in accordance with one example embodiment;

FIG. 5 shows a block diagram of a second control algorithm included in the dual control algorithm shown in FIG. 3 in accordance with one example embodiment; and

FIG. 6 shows a block diagram of a wireless communication system in which various example embodiments of the present disclosure may be implemented.

### DETAILED DESCRIPTION

Various embodiments of the present disclosure are further described in more detail with reference to the accompanying drawings. However, the present disclosure can be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatus and method disclosed herein can be implemented in practice by using any numbers of the embodiments provided herein. Furthermore, it should be understood that any embodiment of the present disclosure can be implemented using one or more of the elements presented in the appended claims.

Unless otherwise stated, any embodiment recited herein as “example embodiment” should not be construed as preferable or having an advantage over other embodiments.

Although the numerative terminology, such as “first”, “second”, “third”, “fourth”, etc., may be used herein to describe various elements or features, it should be understood that these elements or features should not be limited by this numerative terminology. This numerative terminology is used herein only to distinguish one element or feature from another element or feature. For example, in the embodiments disclosed herein, a first control algorithm could be renamed a second control algorithm, and vice versa, without departing from the teachings of the present disclosure.

According to the example embodiments disclosed herein, a User Equipment (UE) (also known as a client device) may refer to an electronic computing device that is configured to perform wireless communications. The UE may be implemented as a mobile station, a mobile terminal, a mobile subscriber unit, a mobile phone, a cellular phone, a smart phone, a cordless phone, a personal digital assistant (PDA), a wireless communication device, a laptop computer, a tablet computer, a gaming device, a netbook, a smartbook, an ultrabook, a medical mobile device or equipment, a biometric sensor, a wearable device (e.g., a smart watch, smart glasses, a smart wrist band, etc.), an entertainment device (e.g., an audio player, a video player, etc.), a vehicular component or sensor (e.g., a driver-assistance system), a smart meter/sensor, an unmanned vehicle (e.g., an industrial robot, a quadcopter, etc.) and its component (e.g., a self-driving car computer), industrial manufacturing equipment, a global positioning system (GPS) device, an Internet-of-Things (IoT) device, an Industrial IoT (IIoT) device, a machine-type communication (MTC) device, a group of Massive IoT (MIoT) or Massive MTC (mMTC) devices/sensors, or any other suitable mobile device configured to support wireless communications. In some embodiments, the UE may refer to at least two collocated and inter-connected UEs thus defined.

As used in the example embodiments disclosed herein, a network node may refer to a fixed point of communication for a UE in a particular wireless communication network. The network node may be referred to as a base transceiver station (BTS) in terms of the 2G communication technology, a NodeB in terms of the 3G communication technology, an evolved NodeB (eNodeB) in terms of the 4G communication technology, and a gNB in terms of the 5G New Radio (NR) communication technology. The network node may serve different cells, such as a macrocell, a microcell, a picocell, a femtocell, and/or other types of cells. The macrocell may cover a relatively large geographic area (for example, at least several kilometers in radius). The microcell may cover a geographic area less than two kilometers in radius, for example. The picocell may cover a relatively small geographic area, such, for example, as offices, shopping malls, train stations, stock exchanges, etc. The femtocell may cover an even smaller geographic area (for example, a home). Correspondingly, the network node serving the macrocell may be referred to as a macro node, the network node serving the microcell may be referred to as a micro node, and so on.

According to the example embodiments disclosed herein, a wireless communication network, in which a UE and a network node communicate with each other, may refer to a cellular or mobile network, a Wireless Local Area Network (WLAN), a Wireless Personal Area Networks (WPAN), a Wireless Wide Area Network (WWAN), a satellite communication (SATCOM) system, or any other type of wireless communication networks. Each of these types of wireless communication networks supports wireless communications according to one or more communication protocol standards. For example, the cellular network may operate according to the Global System for Mobile Communications (GSM) standard, the Code-Division Multiple Access (CDMA) standard, the Wide-Band Code-Division Multiple Access (WCDM) standard, the Time-Division Multiple Access (TDMA) standard, or any other communication protocol standard, the WLAN may operate according to one or more versions of the IEEE 802.11 standards, the WPAN may operate according to the Infrared Data Association (IrDA), Wireless USB, Bluetooth, or ZigBee standard, and the WWAN may operate according to the Worldwide Interoperability for Microwave Access (WiMAX) standard.

The operational efficiency and the overall cost of operation of a wireless communication network may be reduced by means of network function automation and rational radio resource management. All of this may be achieved by using control algorithms based on Machine Learning (ML) approaches in network nodes. Such ML-based control algorithms may allow one to simplify and automate complex network tasks, resulting in a more efficient network operation and improved quality of wireless communications.

However, the existing ML-based control algorithms typically rely on a set on input parameters which must be chosen carefully to obtain the best algorithm performance. It is therefore desirable to make such ML-based control algorithms able to efficiently perform the online adaptation of the set of the most performance-determining parameters which are then used to control the functionality of the ML-based control algorithm itself, when the ML based control algorithm is used for radio configuration parameter optimization. More specifically, it is required to make these ML-based control algorithms:

(1) sufficiently light-weight in terms of computational resources—i.e., such that these algorithms allow the execution of many (several 10's or 100's) algorithm instances for/in the same network node;

(2) robust to dynamically changing radio conditions in a cell—i.e., such that these algorithms allow for nearly real-time adaptation to new radio conditions in each network node (e.g., gNB), ideally even without intervention of additional network entities (e.g., an Operation, Administration, and Maintenance (OAM) function, a Network Data Analytics Function (NWDAF), etc.), and certainly without human intervention; and

(3) flexible to handle a multi-objective optimization in the cell—i.e., such that these algorithms allow the assessment of different optimized radio transmission parameter setups under heterogeneous Key Performance Indicator (KPI) (e.g., Quality-of-Service (QoS)) requirements/constraints.

The example embodiments disclosed herein provide a technical solution that allows mitigating or even eliminating the above-sounded drawbacks peculiar to the prior art. In particular, the technical solution disclosed herein involves using a dual control algorithm to adaptively control and optimize radio configuration parameters (e.g., transmission power control parameters). The dual control algorithm comprises first and second control algorithms, each of which is executed independently whenever certain one or more trigger events occur. The first control algorithm is used for obtaining one or more UE clusters and a KPI requirement for each UE cluster based on UE information, while the second control algorithm is used for obtaining optimized radio configuration parameters for each UE cluster based on the output data of the first control algorithm. The second control algorithm is also configured to monitor its performance and send a special signal to the first control algorithm when its performance degrades. The occurrence of such a signal is among the trigger events that cause the execution of the first control algorithm. The proposed configuration of the dual control algorithm disclosed herein corresponds to all requirements (1)-(3) mentioned above.

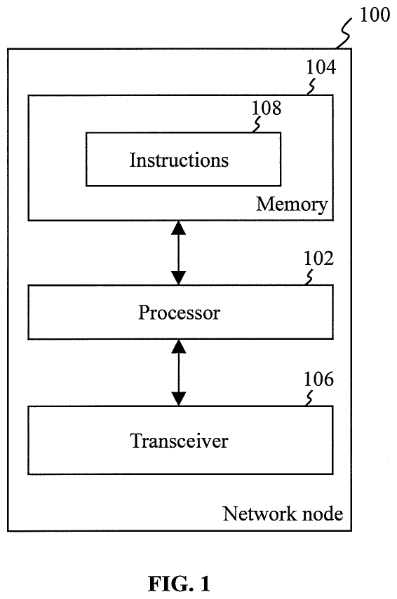

FIG. 1 shows a block diagram of a network node 100 in accordance with one example embodiment. The network node 100 is intended to communicate with one or more UEs in any of the above-described wireless communication networks. As shown in FIG. 1, the network node 100 comprises a processor 102, a memory 104, and a transceiver 106. The memory 104 stores processor-executable instructions 108 which, when executed by the processor 102, cause the processor 102 to perform the aspects of the present disclosure, as will be described below in more detail. It should be noted that the number, arrangement, and interconnection of the constructive elements constituting the network node 100, which are shown in FIG. 1, are not intended to be any limitation of the present disclosure, but merely used to provide a general idea of how the constructive elements may be implemented within the network node 100. For example, the processor 102 may be replaced with several processors, as well as the memory 104 may be replaced with several removable and/or fixed storage devices, depending on particular applications. Furthermore, in some embodiments, the transceiver 106 may be implemented as two individual devices, with one for a receiving operation and another for a transmitting operation. Irrespective of its implementation, the transceiver 106 is intended to be capable of performing different operations required to perform the data reception and transmission, such, for example, as signal modulation/demodulation, encoding/decoding, etc. In other embodiments, the transceiver 106 may be part of the processor 102 itself.

The processor 102 may be implemented as a CPU, general-purpose processor, single purpose processor, microcontroller, microprocessor, application specific integrated circuit (ASIC), field programmable gate array (FPGA), digital signal processor (DSP), complex programmable logic device, etc. It should be also noted that the processor 102 may be implemented as any combination of one or more of the aforesaid. As an example, the processor 102 may be a combination of two or more microprocessors.

The memory 104 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

The processor-executable instructions 108 stored in the memory 104 may be configured as a computer-executable program code which causes the processor 102 to perform the aspects of the present disclosure. The computer-executable program code for carrying out operations or steps for the aspects of the present disclosure may be written in any combination of one or more programming languages, such as Java, C++, or the like. In some examples, the computer-executable program code may be in the form of a high-level language or in a pre-compiled form and be generated by an interpreter (also pre-stored in the memory 104) on the fly.

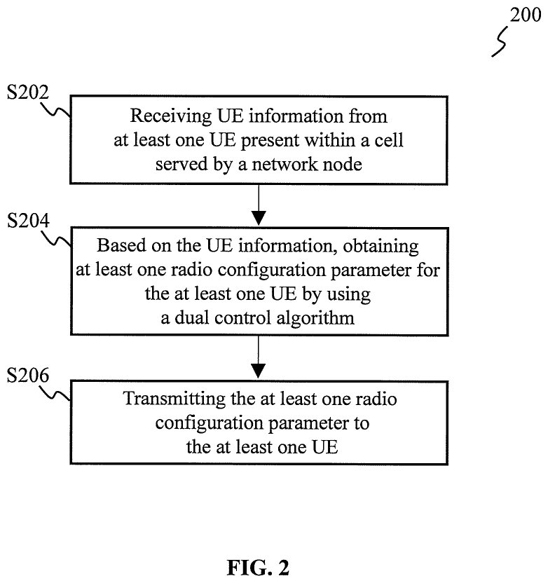

FIG. 2 shows a flowchart of a method 200 for operating the network node 100 in accordance with one example embodiment.

The method 200 starts with a step S202, in which the processor 102 receives (e.g., by using the transceiver 106) UE information from one or more UEs present within a cell served by the network node 100. It should be noted that the UE(s) may transmit the UE information to the network node 100 either in response to a corresponding request from the network node 100, or each time when a connection establishment procedure is initiated (e.g., during the transition of the UE(s) from a Radio Resource Control Idle (RRC_IDLE) or RRC Inactive (RRC_INACTIVE) state to a full RRC connection (RRC_CONNECTED) state), or periodically (e.g., once per minute, hour, etc.). The UE information may comprise at least one of the following:
a UE type/class/category (e.g., the UE type may indicate that the UE(s) is(are) smartphones, tablet computers, vehicle components, etc.),
a type and/or quality of one or more communication services to be used by the UE(s) (e.g., Enhanced Mobile Broadband (eMBB), Ultra-Reliable Low-Latency Communication (URLLC), massive Machine Type Communication (mMTC) services, etc.), and
a type of one or more radio configuration parameters to be used and associated information.

Said associated information may, for example, include UE transmission measurement data and UE-specific configuration information. The UE transmission measurement data may, for example, include a UE transmission power (including, e.g., Multiple-Input Multiple-Output Beamforming (MIMO BF) capabilities), current cell radio capacity/load per service types (current KPIs and performance counters), etc. The UE-specific configuration information may, for example, include a UE throughput, a UE power consumption model, a UE radio energy efficiency, UE positioning information, etc.

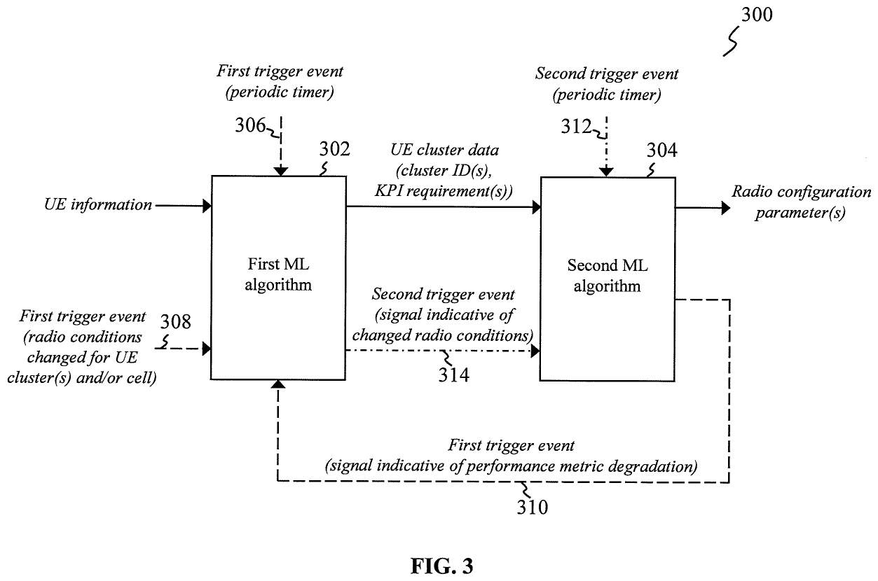

Then, the method 200 proceeds to a step S204, in which the processor 102 obtains, based on the UE information, one or more radio configuration parameters (e.g., one or more radio resources, transmission power control parameters, measurement gaps, UL beamforming parameters, a number of supported timing advance groups, or any combination thereof) for the UE(s) by using the dual control algorithm. The specifics of the dual control algorithm will be discussed below with reference to FIGS. 3-5.

After that, the method 200 goes no to a step S206, in which the processor 102 transmits the obtained radio configuration parameter(s) to the UE(s). This may be done by using at least one of dedicated signaling (e.g., an RRC message) and broadcast signaling (e.g., a Data Radio Bearer (DRB)).

FIG. 3 shows a block diagram of a dual control algorithm 300 in accordance with one example embodiment. The dual control algorithm 300 may be used by the processor 102 of the network node 100 in the step S202 of the method 200 to obtain the radio configuration parameter(s) for the UE(s). As shown in FIG. 3, the dual control algorithm 300 comprises a first control algorithm 302 and a second control algorithm 304 which have forward and feedback connections therebetween. In response to certain one or more trigger events, each of the first control algorithm 302 and the second control algorithm 304 executes its own iterative steps for an intended purpose/functionality, utilising corresponding input data and generating corresponding output data, and potentially with different time periods.

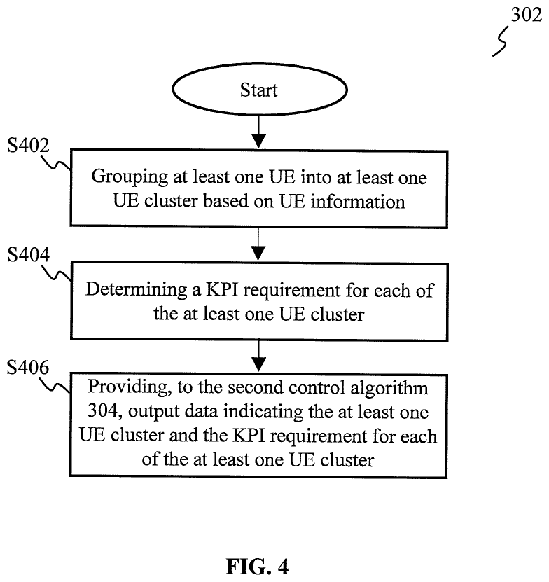

FIG. 4 shows a block diagram of the first control algorithm 302 included in the dual control algorithm 300 in accordance with one example embodiment. As shown in FIG. 4, the first control algorithm comprises steps S402-S406. In the step S402, the first control algorithm 302 groups the UE(s) into one or more UE clusters based on the UE data (e.g., each UE cluster may comprise UEs of the same type). In the step S404, the first control algorithm 302 determines a KPI requirement (e.g., a QoS requirement) for each UE cluster. In the step S406, the first control algorithm 302 provides, to the second control algorithm 304, output data indicating the UE cluster(s) (e.g., cluster ID(s) and associated UE ID(s)) and the KPI requirement(s) for each UE cluster. The first control algorithm 302 may be implemented based on a supervised ML algorithm, an unsupervised ML algorithm, a rule-based algorithm, or any combination thereof. In preferred embodiments, the first control algorithm 302 may use a K-mean clustering algorithm, a K-Nearest-Neighbours (KNN) algorithm, a Support Vector Machine (SVM) algorithm, or any combination thereof.

In one example embodiment, the network node 100 may receive UE-specific historical data for each UE from another network node in the wireless communication network. For example, said another network node may be a network node that has previously served the UE(s) which is(are) now within the cell of the network node 100. The UE-specific historical data may indicate optimized radio configuration (e.g., transmission) parameters in a former timeline, or a UE transmission performance over time, cell condition(s)/load, and/or UE location within the previous cell (these data may be especially useful when supervised learning is used in the dual control algorithm 300). In this case, the step S402 of the first control algorithm 400 may be performed based on the UE information in combination with the UE-specific historical data.

Referring back to FIG. 3, the first control algorithm 302 is executed by the processor 102 of the network node 100 whenever one or more first trigger events 306-310 occur. For convenience, the first trigger events 306-310 for the first control algorithm 302 are schematically shown in FIG. 3 by using long-dash arrows. The occurrence of one of the first trigger events 306-310 is enough to cause the processor 102 to execute the first control algorithm 302.

More specifically, the first trigger event 306 is a trigger event based on a periodic timer (the processor 102 of the network node 100 may start the periodic timer for the first control algorithm 302, e.g., before, after or during the step S202 of the method 200, and execute the first control algorithm 302 whenever the periodic timer expires). The first trigger event 308 is a trigger event based on a change in radio conditions for the cell and/or the UE cluster(s) and/or cell admission control (the processor 102 of the network node 100 may monitor any change in the radio conditions and/or cell admission control, and execute the first control algorithm 302 whenever such a change occurs). The first trigger event 310 is a trigger event based on a signal from the second control algorithm 304, which may indicate that the performance metric of the second control algorithm 304 degrades, whereupon the first control algorithm 302 should update the UE cluster(s) and/or the KPI requirement for each UE cluster (it should be noted that the signal from the second control algorithm 304 is a feedback signal in the configuration of the dual control algorithm 300 which is shown in FIG. 3).

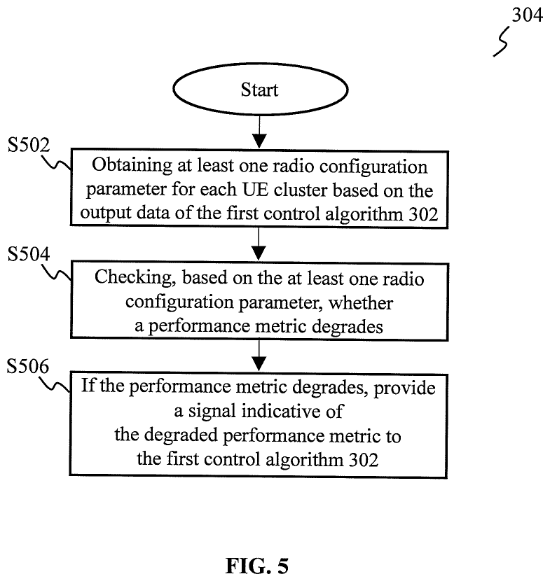

FIG. 5 shows a block diagram of the second control algorithm 304 included in the dual control algorithm 300 in accordance with one example embodiment. As shown in FIG. 5, the second control algorithm 304 comprises steps S502-S506. In the step S502, the second control algorithm 304 obtains the radio configuration parameter(s) based on the output data from the first control algorithm 302. In the step S504, the second control algorithm 304 checks, based on the radio configuration parameter(s), whether the performance metric degrades. In the step S506, if the performance metric degrades, the second control algorithm 304 provides the signal indicative of the degraded performance metric to the first control algorithm 302. The second control algorithm 304 may be based on any ML algorithm. In a preferred embodiment, the second control algorithm 304 may be implemented as a low complexity Reinforcement Learning (RL) algorithm. As for the performance metric, it may be selected from at least one of the following: a learning performance, an algorithm convergence or stability metric, and an objective function. Correspondingly, the degradation of the performance metric may mean at least one of the following:
learning performance degradation/instability (e.g., a temporal difference (TD) changes rapidly);
unaccepted objection function variation (e.g., in case of using an RL algorithm as the second control algorithm 304, its discounted accumulated reward function monotonically decreases); and
invalid/insufficient exploration of an RL algorithm used as the second control algorithm 304) (e.g., the obtained radio configuration parameter(s) is(are) not selected from an explored action range).

Referring back to FIG. 3, the second control algorithm 304 is executed by the processor 102 of the network node 100 whenever one or more second trigger events 312 and 314 occur. For convenience, the second trigger events 312 and 314 for the second control algorithm 304 are schematically shown in FIG. 3 by using dash-dot arrows. The occurrence of one of the second triggers 312 and 314 is enough to cause the processor 102 to execute the second control algorithm 304.

More specifically, similar to the first trigger event 306, the second trigger event 312 is a trigger event based on a periodic timer (the processor 102 of the network node 100 may start the periodic timer for the second control algorithm 304, e.g., before, after or during the step S202 of the method 200, and execute the second control algorithm 304 whenever the periodic timer expires). The second trigger event 314 is a trigger event based on a signal from the first control algorithm 302, which indicates the above-discussed change(s) in the radio conditions for the cell and/or the UE cluster(s) and/or cell admission control (it should be noted that the signal from the first control algorithm 302 is a feedforward signal in the configuration of the dual control algorithm 300 which is shown in FIG. 3).

Thus, the configuration of the dual control algorithm 300 provides for the interconnection of the first control algorithm 302 and the second control algorithm 304 via the specified trigger events (i.e., based on the above-indicated signal from the first control algorithm 302 and/or the above-indicated signal from the second control algorithm 304). This means that the first control algorithm 302 may trigger the execution of the second control algorithm 304, and vice versa, even when all other triggers are absent (i.e., when there is no periodic timer, and/or no change in the radio conditions for the cell and/or the UE cluster(s) and/or cell admission control).

It should be also noted that the first control algorithm 302 and the second control algorithm 304 may be executed in non-successive order. Of course, the second control algorithm 304 needs the output data from the first control algorithm 302 during at least its first iteration, but afterwards the second control algorithm 304 may operate independently from the first control algorithm 302 (e.g., parallel to the first control algorithm 302) based on the output data received during the at least one first iteration. In general, the first control algorithm 302 may be executed independently and iteratively to generate the UE cluster(s) and the cluster-related data (the cluster ID(s), the UE ID(s) associated with each UE cluster, and the KPI requirement for each UE cluster), and, at the same time, the second control algorithm 304 may be executed independently and iteratively to generate the optimized radio configuration parameter(s) for each UE cluster.

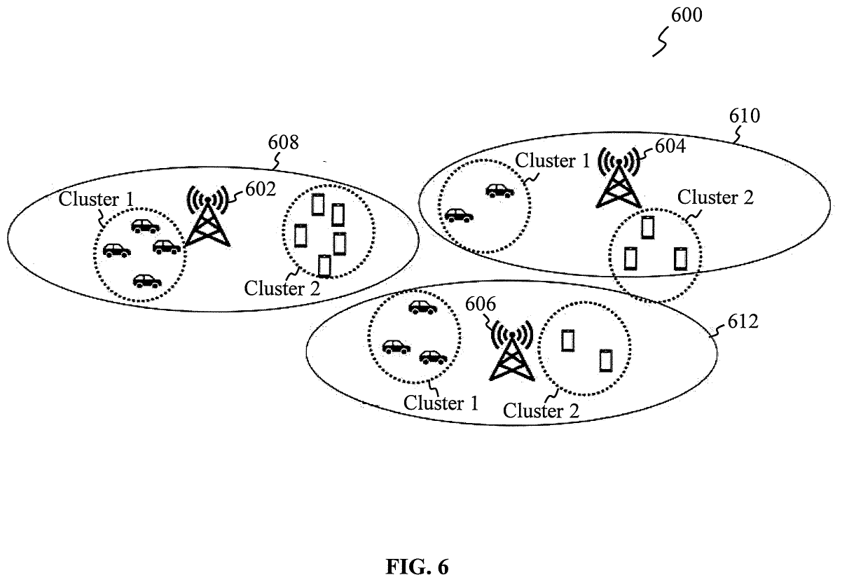

FIG. 6 shows a block diagram of a wireless communication system 600 in which various example embodiments of the present disclosure may be implemented. The system 600 comprises three network nodes 602-606 serving cells 608-612, respectively. Each of the network nodes 602-606 is assumed to be implemented as the network node 100 that is configured to operate in accordance with the method 200 based on the dual control algorithm 300. It is additionally assumed that each of the network nodes 602-606 generates two similar UE Clusters 1 and 2 by executing the first control algorithm 302. More specifically, UE Cluster 1 comprises URLLC UEs (e.g., vehicle components), while UE Cluster 2 comprises eMBB UEs (e.g., smartphones). Each of UE Clusters 1 and 2 is characterized by a distinct QoS requirement. Furthermore, by executing the second control algorithm 304 implemented as a RL algorithm, the optimal QoS-aware UL radio resource allocation may be achieved via the proper designation of reward and cost functions to jointly maximize an average cluster throughput for the UEs of Cluster 1 and minimize an average latency for the UEs of Cluster 0. In this example, due to UE mobility, radio conditions for each of UE Clusters 1 and 2 would change, thereby causing each of the network nodes 602-606 to update the cluster-related data. Thus, (at least) the first trigger event 308 for the first control algorithm 302 will push the first control algorithm 302 to update and allocate the two types of the UEs into new UE clusters, which subsequently triggers the second control algorithm 304 to run for optimal UL radio resource allocation.

In another example, the UEs present in each of the cells 608-612 may differ from each other in a relative Reference Signal Received Power (RSRP). Then, the first control algorithm 302 may be used in each of the network node 602-606 to provide the enhanced auto-clustering of the UEs based on any of the first trigger events 306-310 (e.g., due to the varying radio conditions as indicated in the first trigger event 308 for the first control algorithm 302). At the same time, the second control algorithm 304 may be implemented as the RL-based control algorithm disclosed in the Finnish Patent Application No. 20215727, in order to solve the problem of UL Transmit Power Control (TPC) parameteroptimization beyond the average cell/UE cluster throughput. However, the second control algorithm is not limited to cell throughput/Spectral Efficiency (SE) maximization and may also be aimed at energy efficiency or jointly optimization.

It should be noted that each step or operation of the method 200, as well as the algorithms 302 and 304, or any combinations of the steps or operations, can be implemented by various means, such as hardware, firmware, and/or software. As an example, one or more of the steps or operations described above can be embodied by processor executable instructions, data structures, program modules, and other suitable data representations. Furthermore, the processor-executable instructions which embody the steps or operations described above can be stored on a corresponding data carrier and executed by the processor 102. This data carrier can be implemented as any computer-readable storage medium configured to be readable by said at least one processor to execute the processor executable instructions. Such computer-readable storage media can include both volatile and nonvolatile media, removable and non-removable media. By way of example, and not limitation, the computer readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the example embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. A network node in a wireless communication network, comprising:
at least one processor; and
at least one non-transitory memory including a computer program code;
wherein the at least one memory and the computer program code are configured to, with the at least one processor, cause the network node to:
receive User Equipment (UE) information from at least one UE present within a cell served by the network node;
based on the UE information, obtain at least one radio configuration parameter for the at least one UE by using a dual control algorithm; and
transmit the at least one radio configuration parameter to the at least one UE;
characterized in that the dual control algorithm comprises a first control algorithm and a second control algorithm;
wherein the first control algorithm is configured, whenever at least one first trigger event occurs, to: (i) group the at least one UE into at least one UE cluster based on the UE information; (ii) determine at least one Key Performance Indicator (KPI) requirement for each of the at least one UE cluster; and (iii) provide, to the second control algorithm, output data indicating the at least one UE cluster and the at least one KPI requirement for each of the at least one UE cluster;
wherein the second control algorithm has a performance metric and is configured, whenever at least one second trigger event occurs, to: (i) obtain the at least one radio configuration parameter for each of the at least one UE cluster based on the output data from the first control algorithm; (ii) check, based on the at least one radio configuration parameter, whether the performance metric degrades; and (iii) if the performance metric degrades, provide a signal indicative of the degraded performance metric to the first control algorithm; and
wherein the at least one second trigger event is different from the at least one first trigger event, and the at least one first trigger event comprises an event at which the signal indicative of the degraded performance metric is provided to the first control algorithm.

2. The network node of claim 1, wherein the at least one memory and the computer program code are further configured to, with the at least one processor, cause the network node to start a periodic timer for the first control algorithm, and wherein the at least one first trigger event further comprises an event at which the periodic timer for the first control algorithm expires.

3. The network node of claim 1, wherein the at least one memory and the computer program code are further configured to, with the at least one processor, cause the network node to start a periodic timer for the second control algorithm, and wherein the at least one second trigger event comprises an event at which the periodic timer for the second control algorithm expires.

4. The network node of claim 1, wherein the at least one memory and the computer program code are further configured to, with the at least one processor, cause the network node to monitor a radio condition for the cell and/or the at least one UE cluster, and wherein the at least one first trigger event further comprises an event at which the radio condition for the cell and/or any of the at least one UE cluster changes.

5. The network node of claim 4, wherein the first control algorithm is further configured to provide, to the second control algorithm, a signal indicative of the changed radio condition for the cell and/or any of the at least one UE cluster, and wherein the at least one second trigger event further comprises an event at which the signal indicative of the changed radio condition for the cell and/or any of the at least one UE cluster is provided to the second control algorithm.

6. The network node of claim 1, wherein the UE information comprises at least one of:
a UE type,
a type and/or quality of at least one communication service to be used, and
a type of at least one radio configuration parameter to be used.

7. The network node of claim 1, wherein the KPI requirement comprises at least one of a Quality-of-Service (QoS) requirement, a throughput requirement, and an uplink (UL) power requirement.

8. The network node of claim 1, wherein the at least one radio configuration parameter comprises at least one of a radio resource, a transmission power control parameter, a measurement gap, an UL beamforming parameter, and a number of supported timing advance groups.

9. The network node of claim 1, wherein the first control algorithm comprises at least one of a Machine Learning (ML) algorithm and a rule-based algorithm.

10. The network node of claim 1, wherein the second control algorithm comprises a ML algorithm.

11. The network node of claim 1, wherein the at least one memory and the computer program code are further configured to, with the at least one processor, cause the network node to receive, from another network node, UE-specific historical data for the at least one UE, the UE-specific historical data relating to a UE transmission performance over time and/or the UE transmission performance over a UE location within the cell, and wherein the first control algorithm is configured to group the at least one UE into the at least one UE cluster based on the UE information and the UE-specific historical data.

12. A method for operating a network node in a wireless communication network, comprising:
receiving User Equipment (UE) information from at least one UE present within a cell served by the network node;
based on the UE information, obtaining at least one radio configuration parameter for the at least one UE by using a dual control algorithm; and
transmitting the at least one radio configuration parameter to the at least one UE;
characterized in that the dual control algorithm comprises a first control algorithm and a second control algorithm;
wherein the first control algorithm is configured, whenever at least one first trigger event occurs, to: (i) group the at least one UE into at least one UE cluster based on the UE information; (ii) determine at least one Key Performance Indicator (KPI) requirement for each of the at least one UE cluster; and (iii) provide, to the second control algorithm, output data indicating the at least one UE cluster and the at least one KPI requirement for each of the at least one UE cluster;
wherein the second control algorithm has a performance metric and is configured, whenever at least one second trigger event occurs, to: (i) obtain the at least one radio configuration parameter for each of the at least one UE cluster based on the output data from the first control algorithm; (ii) check, based on the at least one radio configuration parameter, whether the performance metric degrades; and (iii) if the performance metric degrades, provide a signal of the degraded performance metric to the first control algorithm; and
wherein the at least one second trigger event is different from the at least one first trigger event, and the at least one first trigger event comprises an event at which the signal of the degraded performance metric is provided to the first control algorithm.

13. The method of claim 12, further comprising starting a periodic timer for the first control algorithm, and wherein the at least one first trigger event further comprises an event at which the periodic timer for the first control algorithm expires.

14. The method of claim 12, further comprising starting a periodic timer for the second control algorithm, and wherein the at least one second trigger event comprises an event at which the periodic timer for the second control algorithm expires.

15. The method of claim 12, further comprising monitoring a radio condition for the cell and/or the at least one UE cluster, and wherein the at least one first trigger event further comprises an event at which the radio condition for the cell and/or any of the at least one UE cluster changes.

16. The method of claim 15, wherein the first control algorithm is further configured to provide, to the second control algorithm, a signal indicative of the changed radio condition for the cell and/or any of the at least one UE cluster, and wherein the at least one second trigger event further comprises an event at which the signal indicative of the changed radio condition for the cell and/or any of the at least one UE cluster is provided to the second control algorithm.

17. The method of claim 12, wherein the UE information comprises at least one of:
a UE type,
a type and/or quality of at least one communication service to be used, and
a type of at least one radio configuration parameter to be used.

18. The method of claim 12, wherein the KPI requirement comprises at least one of a Quality-of-Service (QoS) requirement, a throughput requirement, and an uplink (UL) power requirement.

19. The method of claim 12, wherein the at least one radio configuration parameter comprises at least one of a radio resource, a transmission power control parameter, a measurement gap, an UL beamforming parameter, and a number of supported timing advance groups.

20. The method of claim 12, wherein the first control algorithm comprises at least one of a Machine Learning (ML) algorithm and a rule-based algorithm.

21. The method of claim 12, wherein the second control algorithm comprises a ML algorithm.

22. The method of claim 12, further comprising receiving, from another network node, UE-specific historical data for the at least one UE, the UE-specific historical data relating to a UE transmission performance over time and/or the UE transmission performance over a UE location within the cell, and the first control algorithm is configured to group the at least one UE into the at least one UE cluster based on the UE information and the UE-specific historical data.

23. A computer program product comprising a non-transitory computer-readable storage medium, wherein the computer-readable storage medium stores a computer code which, when executed by at least one processor, causes the at least one processor to perform the method according to claim 12.
